(19) United States
(12) Patent Application Publication
(10) Pub. No.: US 2020/0338960 A1
(43) Pub. Date: Oct. 29, 2020

(54) AIR CONDITIONER FOR MOTOR VEHICLES

(71) Applicant: Luca BARIN, Varedo (IT)

(72) Inventor: Luca BARIN, Varedo (IT)

(21) Appl. No.: 16/959,808

(22) PCT Filed: Dec. 28, 2018
(86) PCT No.: PCT/IB2018/060677

§ 371 Date: Jul. 2, 2020

(30) Foreign Application Priority Data
Jan. 2, 2018 (IT) 102018000000051

(51) Int. Cl. B60H 1/22

(52) U.S. Cl. CPC B60H 1/2209

(57) ABSTRACT

An air conditioner for the air conditioning of the passenger compartment of a vehicle of the type provided with an internal combustion engine and with a tank adapted to contain a fuel for supplying the engine, includes an absorption refrigeration unit.

The absorption refrigeration unit includes a refrigeration circuit adapted to contain a fluid compound and has at least one evaporator arranged in thermal communication with the passenger compartment of the vehicle, and
a burner supplied by the fuel contained in the tank of the vehicle, arranged in thermal communication with the refrigeration circuit and configured to heat the fluid compound so as to cause the evaporation of at least part of it by making it circulate in the refrigeration circuit toward the evaporator.

### TECHNICAL FIELD

The present disclosure relates to an air conditioner for motor vehicles, particularly, but not exclusively, useful and practical for cooling and heating the passenger compartments of cars, commercial vehicles and work vehicles.

### BACKGROUND

Nowadays the air conditioning systems that make it possible to cool and/or heat the passenger compartment are considered an almost indispensable accessory for any vehicle provided with a passenger compartment.

Air conditioners are in fact installed on the vast majority of vehicles on the market, both those for private use, such as typically cars, and those for commercial, tourist or industrial use, such as for example vans, coaches, agricultural machinery and construction site vehicles.

The air conditioners installed in vehicles make it possible to maintain optimal temperature and humidity conditions in the passenger compartment, even if the outside temperatures are very high or very low, to the advantage of the comfort and health of the occupants.

Conventional air conditioners for vehicles are constituted by cooling systems that use a compression/expansion thermodynamic cooling cycle.

In more detail, these conventional systems comprise an electromechanical compressor that compresses a gas, the temperature of which increases owing to the reduction in its volume.

The compressed gas then goes to a condenser, constituted by a heat exchanger which is in thermal communication with the outside environment, where it loses heat, moving from the gaseous phase to the liquid phase.

Once cooled, the pressurized fluid goes to a second heat exchanger in which it is placed in thermal communication with the air of the environment to be cooled and in which it is made expand, by lowering its pressure, through a throttle valve inside which there is a nozzle that makes the liquid expand with the minimum possible entropy. In practice, the liquid, through the throttle valve, is vaporized, cooling the surrounding air.

Once it has passed through the second heat exchanger, the low-pressure fluid returns to the compressor to begin a new cycle.

According to the known art, the heating function is instead usually achieved using the heat generated by the engine of the vehicle, by conveying the air, which is heated by making it pass through an adapted radiator connected to the cooling circuit of the engine, into the passenger compartment.

Sometimes, in addition to the radiator, there is also an electric heating element which makes it possible to heat the air more rapidly in the initial phase of use of the vehicle, during which the temperature of the engine is still relatively low.

The air conditioning systems for vehicles in use today, while very is useful and practical, exhibit the considerable limitation of being able to operate exclusively with the engine of the vehicle running.

In fact the electromechanical compressor needs to be powered, directly or indirectly, by the engine of the vehicle.

Furthermore, the heating of the air can also only happen by virtue of the heat generated by the engine during its operation.

Some conventional air conditioning systems for vehicles overcome this limitation by providing an additional independent engine for supplying power to the compressor and/or to electric heating elements for heating. This solution however has the considerable drawback of being very noisy, as well as being very heavily polluting owing to the emissions of the engine.

Furthermore, this solution is also economically disadvantageous because of the fuel consumption of the supplementary engine.

Another drawback of this solution is the costs of installation and maintenance of the supplementary engine.

Another drawback which is common to all conventional air conditioning systems for vehicles is the fact that the cooling gases used are particularly harmful to the environment.

Another drawback of conventional air conditioning systems for vehicles is the fact that the presence of moving electromechanical parts (such as for example the parts of the compressor) makes them particularly prone to malfunctions and not entirely reliable.

### SUMMARY

The present disclosure provides an air conditioner for vehicles that solves the above technical problem, eliminates the drawbacks and overcomes the limitations of the known art, by making it possible to cool and heat the passenger compartment even when the engine is switched off.

Within this aim, the present disclosure provides an air conditioning system for vehicles that has a lower environmental impact when compared to the known art.

The disclosure relates to providing an air conditioning system for vehicles that is quieter than the known art.

The disclosure relates to providing an air conditioning system for vehicles with low fuel consumption.

The disclosure further relates to providing an air conditioning system for vehicles that is more reliable and less prone to malfunctions when compared to the known art.

The disclosure also relates to providing an air conditioning system for vehicles that is easy to implement and economically competitive when compared to the known art.

This aim and these and other advantages which will become better apparent hereinafter are achieved by providing an air conditioner for the air conditioning of the passenger compartment of a vehicle of the type provided with an internal combustion engine and with a tank adapted to contain a fuel for supplying said engine,

characterized in that it comprises an absorption refrigeration unit which in turn comprises:
a refrigeration circuit adapted to contain a fluid compound and comprising at least one evaporator arranged in thermal communication with the passenger compartment of the vehicle and

a burner supplied by said fuel contained in the tank of the vehicle, arranged in thermal communication with said refrigeration circuit and configured to heat said fluid compound so as to cause the evaporation of at least part of it by making it circulate in the refrigeration circuit toward said evaporator.

This aim and these and other advantages which will become better apparent hereinafter are also achieved by providing a method according to the claims.

### BRIEF DESCRIPTION OF THE DRAWINGS

Further characteristics and advantages of the disclosure will become is better apparent from the description of two preferred, but not exclusive, embodiments of an air conditioner for motor vehicles, which are illustrated by way of non-limiting example with the aid of the accompanying drawings wherein:

FIG. 1 is a block diagram of an air conditioner for motor vehicles according to the disclosure;

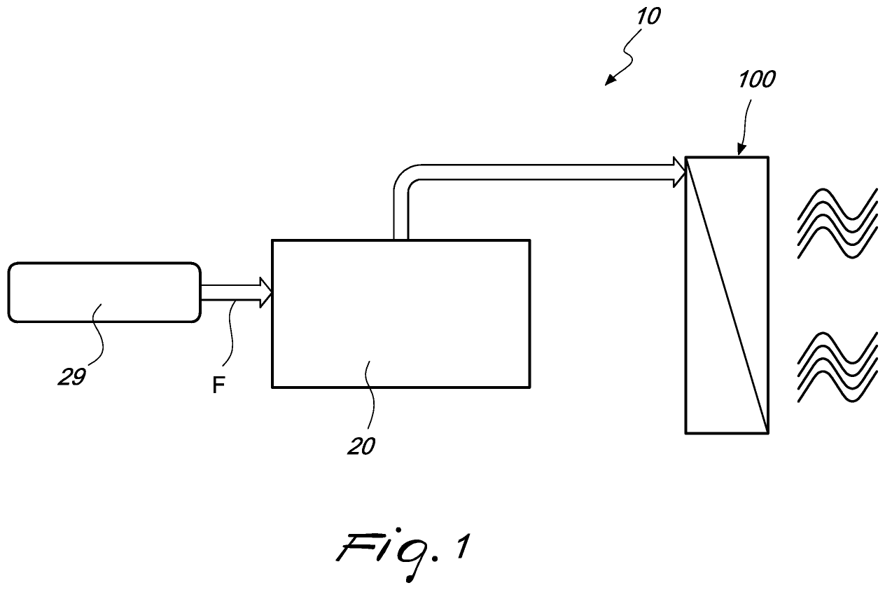

FIG. 2 is a block diagram of a possible improved embodiment of the air conditioner for motor vehicles according to the disclosure;

FIG. 3 is a schematic diagram of a possible embodiment of an air conditioner according to the disclosure, in the cooling configuration;

FIG. 4 is a schematic diagram of the air conditioner in FIG. 3, in the cooling configuration; and

FIG. 5 is a schematic diagram of a possible embodiment of the hydraulic circuit for supplying an air conditioner according to the disclosure.

### DETAILED DESCRIPTION OF THE DRAWINGS

With reference to the figures, the air conditioner for motor vehicles, motor boats and the like, generally designated by the reference numeral 10, is designed for the air conditioning of the passenger compartment A of a motor vehicle, and more precisely of a vehicle provided with an internal combustion engine and with a tank 29 adapted to contain a fuel F for supplying such engine.

The term motor vehicle therefore means any vehicle, both for carrying passengers (such as for example automobiles, minibuses, coaches, camper vans etc.), and for transporting goods (such as for example trucks, forklifts with enclosed cabins etc.), and also works vehicles (such as for example agricultural vehicles or construction site vehicles with enclosed cabins). In practice, the present disclosure can be used on any vehicle as long as it is provided with a passenger compartment and with an engine that is supplied at least partially with the fuel F present in a tank 29 (therefore also including “hybrid” vehicles).

The fuel F should also be understood, in very general terms, to be any fuel, liquid or gas, that is adapted to supply an engine (such as for example gasoline, Diesel fuel, LPG, methane etc.) usually contained in the tank 29 of the vehicle.

According to the disclosure, the air conditioner 10 comprises an absorption refrigeration unit 100 which in turn comprises a refrigeration circuit 90 and a burner 20 which is arranged in thermal communication with such refrigeration circuit 90 and supplied with the fuel F present in the tank 29 of the vehicle (i.e. the same fuel F that supplies the engine of the vehicle).

It should be noted that, hereinafter, the term “in thermal communication” means functionally connected so as to be able to mutually exchange heat, i.e. that two elements described as being “in thermal communication” means they are capable of exchanging heat either directly (by contact, irradiation or convection) or indirectly (by being connected by a thermal conductor or a flow of a heat transfer fluid).

Returning to the air conditioner 10, according to the disclosure, the refrigeration circuit 90 comprises at least one evaporator 50 arranged in thermal communication with the passenger compartment A of the vehicle.

At least during operation, contained in the refrigeration circuit 90 is a fluid compound SR, which flows inside the circuit 90, partially in the liquid phase and partially in the gaseous phase, as normally occurs in conventional absorption refrigeration circuits and as will become clearer below.

The fluid compound SR is preferably constituted by a binary compound SR which comprises a refrigerant fluid R and a solvent S.

Even more preferably, such binary compound SR is constituted by lithium bromide and water (H₂O—BrLi), where the water (H₂O) is the refrigerant fluid R and the lithium bromide (BrLi) is the solvent S, or by ammonia and water (NH₃—H₂O), where the ammonia (NH₃) is the refrigerant fluid R and the water (H₂O) is the solvent S.

Note that such binary compounds are less harmful to the environment is than the refrigerant gases usually used in air conditioners that use a compressor.

In other possible embodiments, the fluid compound SR is constituted by any other chemical solution that is adapted to make an absorption thermodynamic cycle work.

The refrigeration circuit (90) is, according to the disclosure, configurable at least in a cooling configuration for the cooling of the passenger compartment (A) and preferably also in a heating configuration for the heating of the passenger compartment (A). The configuration of the refrigeration circuit 90, in the cooling configuration and optionally in the heating configuration, is carried out according to the known art, preferably according to what is usually carried out in conventional absorption heat pumps.

The switch from the cooling configuration to the heating configuration also occurs with conventional methods.

Preferably, there is also a user interface provided with a thermostat and with an electronic control unit that enables the user to control the operation of the refrigeration unit 100 and optionally to switch from the cooling configuration to the heating configuration.

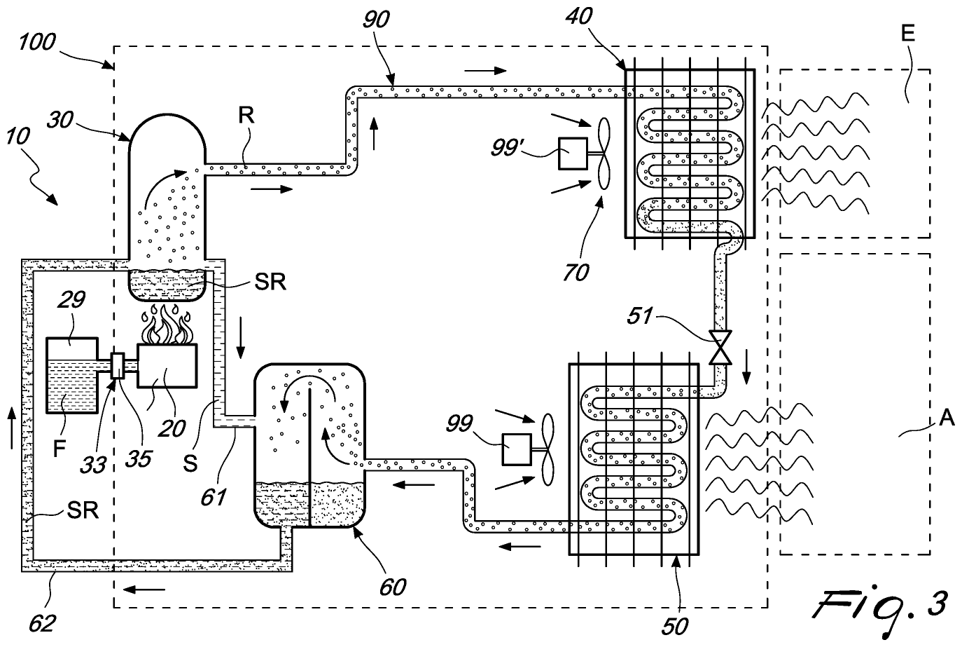

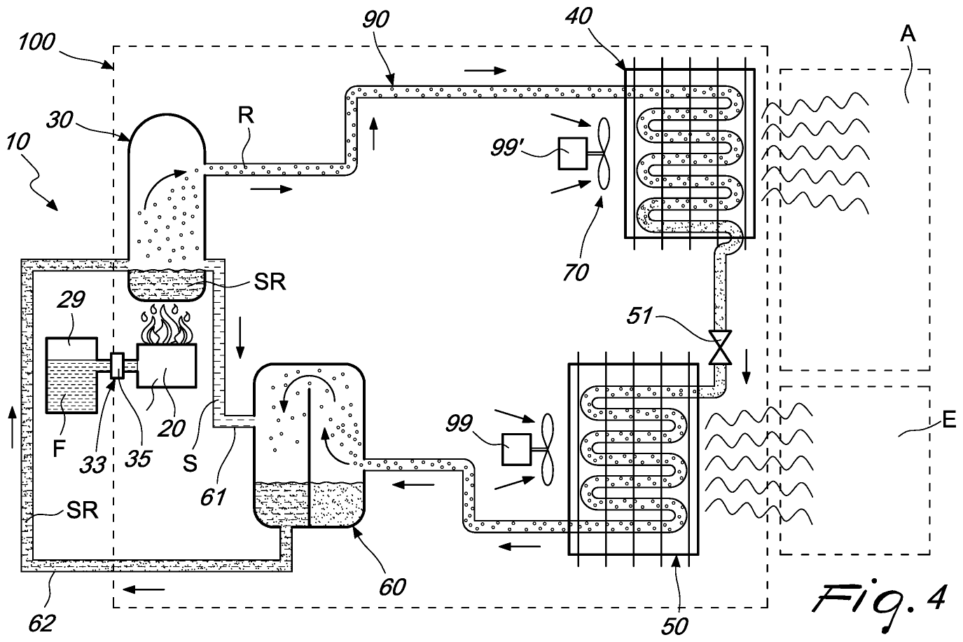

One of the possible embodiments of the refrigeration circuit 90 is shown purely schematically in FIGS. 3 and 4 where the circuit 90 is shown, respectively, in the cooling configuration and in the heating configuration.

With reference to FIGS. 3 and 4, the burner 20 is, as mentioned, in thermal communication with the refrigeration circuit 90 and, more precisely, it is configured to heat the fluid compound SR so as to cause the evaporation of at least part of it by making it circulate in the circuit 90 toward the evaporator 50.

In more detail, in the preferred embodiments, the burner 20 heats the binary compound SR, causing the evaporation of a part comprising the refrigerant fluid R, thus separating it from the solvent S and creating a pressure that pushes it into the circuit 90 toward the evaporator 50.

Preferably, such heating of the binary compound SR with consequent separation of the refrigerant fluid R occurs inside a generation chamber 30, which is constituted for example by a desorber or a boiler (or by what in the sector is generally called a “generator”), arranged in thermal communication with the burner 20.

In the example shown schematically in FIG. 3, the refrigeration circuit 90 comprises a generation chamber 30 in thermal communication with the burner 20 and in fluid communication with a condenser 40, the condenser 40 being in thermal communication with the outside environment E and in fluid communication with the evaporator 50, the evaporator 50 being in fluid communication with an absorption chamber 60, the absorption chamber 60 being in turn in fluid communication with the generation chamber 30.

It is useful to note that indicating two elements as being “in fluid communication” means, here, that those two elements are connected, preferably by way of a duct, so that a fluid can flow from one element to the other.

Returning in more detail to the elements that, in the example shown, make up the refrigeration circuit 90, the condenser 40 is constituted preferably by a heat exchanger (for example a coil) in which the refrigerant fluid R transfers heat to the outside environment E (in the cooling configuration) or to the passenger compartment A (in the heating configuration), going from the gaseous phase to the liquid phase.

As is known, the vaporizer 50 is an element inside which the refrigerant fluid R is caused to evaporate at very low pressure, in the process cooling down and absorbing heat from the surrounding air, thus cooling it (and therefore absorbing heat from the passenger compartment A when the refrigeration circuit 90 is in the cooling configuration or from the outside environment E when it is in the heating configuration).

Note that, preferably, in the heating configuration the condenser 40 is arranged in thermal communication with the passenger compartment A and the evaporator 50 is arranged in thermal communication with the outside environment E, so that heat is released by the refrigerant fluid R to the passenger compartment A and heat is absorbed from the outside environment E.

By contrast, in the cooling configuration, the condenser 40 is arranged in thermal communication with the outside environment E and the evaporator 50 is arranged in thermal communication with the passenger compartment A, so that heat is transferred from the refrigerant fluid R to the outside environment E and heat is absorbed from the passenger compartment A.

The transition of the refrigerant fluid R to the vapor state at low pressure is caused preferably by at least one throttle valve 51 arranged upstream of the evaporator 50.

In order to facilitate the passage of the cooled air from the evaporator 50 (and optionally, in the heating configuration, of the heated air from the condenser 40) to the passenger compartment, there can be a ventilation system which comprises one or more ventilation elements 99, 99′ such as for example one or more fans.

Optionally the evaporator 50 and/or the condenser 40 is arranged in thermal communication with a heat transfer liquid, preferably water, which in turn is arranged in thermal communication with the passenger compartment A (for example circulating inside a circuit that comprises heat exchangers that are arranged in thermal communication with the passenger compartment A).

The absorption chamber 60 is connected to the generation chamber 30 by way of a delivery duct 61 for the passage of the solvent S (or in any case of part of the binary compound SR that is not evaporated and is low in refrigerant fluid R) from the generation chamber 30 to the absorption chamber 60 and a return duct 62 for the passage of the binary compound SR (recombined in the absorption chamber 60) from the absorption chamber 60 to the generation chamber 30.

The absorption chamber 60 is, in other words, a chamber in which the refrigerant fluid R originating from the vaporizer 50 and the solvent S originating from the generation chamber 30 merge, so as to be able to recombine to form the binary compound SR.

In practice, the burner 20 heats the binary compound SR in the generation chamber 30 and causes the evaporation of at least part of the refrigerant fluid R, separating it from the solvent S and propelling it, in the gaseous phase, toward the condenser 40, in which the refrigerant fluid R condenses, releasing heat, and then toward the vaporizer 50, in which it vaporizes, absorbing heat, and then toward the absorption chamber 60 in which it recombines with the solvent S, reconstituting the binary compound SR, which returns finally to the generation chamber 30.

As mentioned, one of the peculiarities of the disclosure is that the burner 20 is supplied by the fuel already present in the tank 29 of the vehicle for supplying the engine.

In more detail, the air conditioner 10 is preferably provided with a hydraulic supply system 33 for transferring the fuel F from the tank 29 of the vehicle to the burner 20.

In a preferred embodiment, such hydraulic supply system 33 comprises a drawing duct 38 which has one end 39 arranged inside the tank 29 of the vehicle.

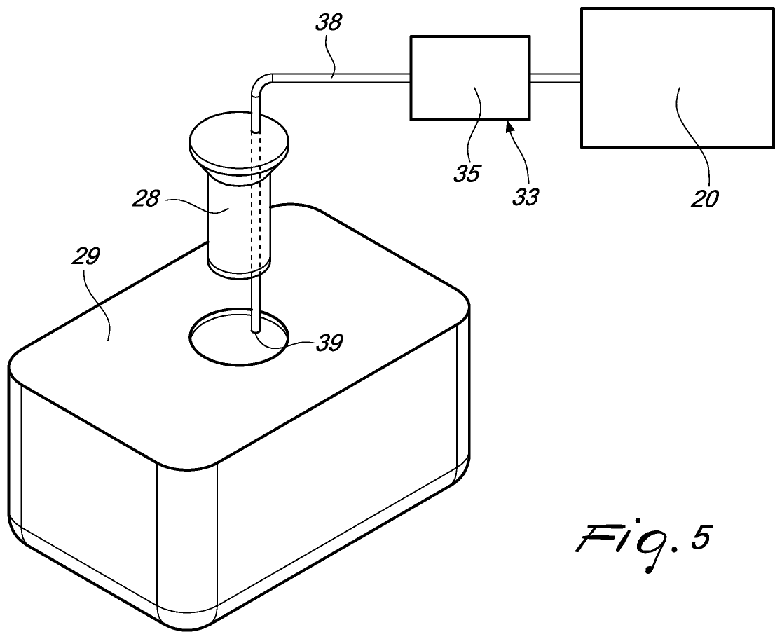

A possible embodiment of this hydraulic system 33 is shown in FIG. 5 and requires the installation of a drawing duct 38 on the floating stopcock 28 which is usually present in the tank 29 of a vehicle; in other embodiments, not shown, the drawing duct 38 can be inserted into the tank 29 with other means, according to the type of tank.

In another embodiment, not shown, the hydraulic supply circuit 33 comprises a supplementary tank arranged in fluid communication with the burner 20 and with the tank 29 of the vehicle; such supplementary tank, in practice, is connected directly with the tank 29, or with the refueling duct of the vehicle, so that when the tank 29 of the vehicle is refilled with fuel F, part of the fuel F flows into such supplementary tank.

The supplementary tank can, optionally, also comprise a refueling duct in order to be refueled independently.

Preferably, the hydraulic supply system 33 also comprises a dosage pump 35 for the creation of a flow of fuel F from the tank 29 of the vehicle to the burner 20 (or optionally from the supplementary tank to the burner 20). The dosage pump 35 is conveniently configured to regulate such flow as a function of the thermal power required of the burner 20.

In practice, the dosage pump 35 doses the rate of flow of the fuel F toward the burner 20, increasing it when the burner 20 has to dispense more thermal power and decreasing it when the burner 20 has to dispense less thermal power.

Note that, since the burner 20 operates independently of the engine of the car, burning the fuel F for its own use, and the air-conditioning unit 100 does not require further sources of energy, the air conditioner 10 can operate even with the engine of the vehicle switched off, even for long periods.

Furthermore, the burner 20 has a considerably lower emission of sound than the electricity generators that are sometimes employed in the known art.

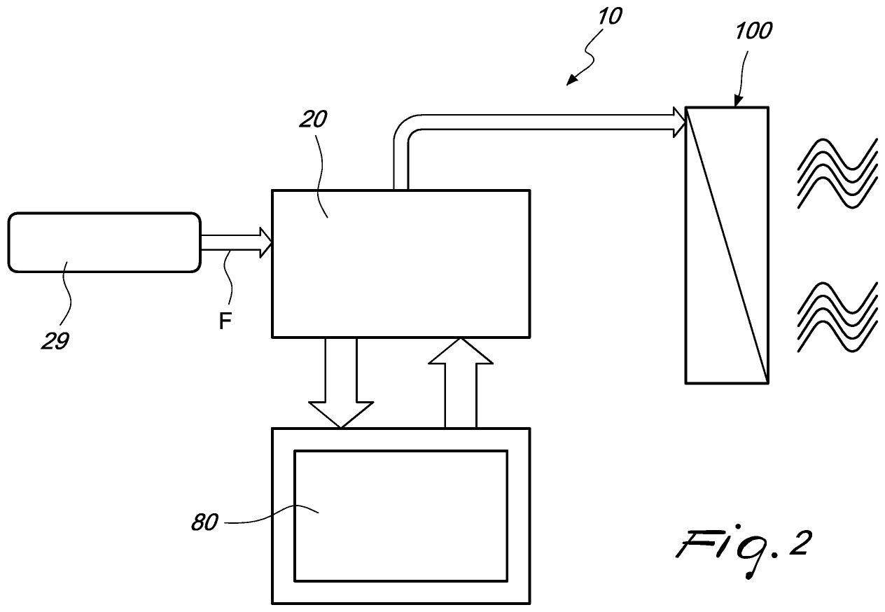

In a possible improved embodiment, shown in FIG. 2, the air conditioner 10 also comprises a thermoelectric generator 80, arranged in thermal communication with the burner 20, so as to generate electric power from the heat generated by the burner 20, for powering elements that are complementary to the operation of the air conditioner 10.

In other words, the thermoelectric generator 80 powers all the components of the air conditioner that need an electricity supply, such as for example the electronic control unit, the fans, the user interface, any pumps present in the circuit etc. In this manner the air conditioner 10 is electrically autonomous and, differently from conventional air conditioners which have to draw energy for example from the battery of the vehicle, it can operate without drawing energy from external sources.

Finally it should be noted that, since in the air conditioner according to the disclosure there are no moving electromechanical parts, it is particularly reliable and not prone to malfunctions.

Operation of the air conditioner 10 is clear and evident from the foregoing description.

In practice it has been found that the air conditioner for motor vehicles, according to the present disclosure, achieves the intended aim and advantages in that it makes it possible to cool, and optionally heat, the passenger compartment even when the engine is switched off.

Another advantage of the air conditioner, according to the disclosure, is that it has a lower environmental impact when compared to the known art.

Another advantage of the air conditioner, according to the disclosure, is that it is quieter with respect to the known art.

Another advantage of the air conditioner, according to the disclosure, is that it has low fuel consumption.

Another advantage of the air conditioner, according to the disclosure, is in that it is more reliable and less prone to malfunctions with respect to the known art.

Another advantage of the air conditioner, according to the disclosure, is that it is easy to implement and economically competitive when compared to the known art.

The air conditioner for motor vehicles thus conceived is susceptible of numerous modifications and variations, all of which are within the scope of the appended claims.

Moreover, all the details may be substituted by other, technically equivalent elements.

In practice the materials employed, provided they are compatible with the specific use, and the contingent dimensions and shapes, may be any according to requirements.

The disclosures in Italian Patent Application No. 102018000000051 from which this application claims priority are incorporated herein by reference.

1.-11. (canceled)

12. An air conditioner for the air conditioning of a passenger compartment of a vehicle of the type provided with an internal combustion engine and with a tank adapted to contain a fuel for supplying said engine,
comprising an absorption refrigeration unit which comprises:
a refrigeration circuit adapted to contain a fluid compound and comprising at least one evaporator arranged in thermal communication with the passenger compartment of the vehicle, and
a burner supplied by said fuel contained in the tank of the vehicle, arranged in thermal communication with said refrigeration circuit and configured to heat said fluid compound so as to cause the evaporation of at least part of it by making it circulate in the refrigeration circuit toward said evaporator.

13. The air conditioner according to claim 12, wherein said fluid compound is a binary compound comprising a refrigerant fluid and a solvent.

14. The air conditioner according to claim 13, wherein said binary compound is one of the following:
lithium bromide and water (H₂O—BrLi), wherein the water (H₂O) is the refrigerant fluid (R) and the lithium bromide (BrLi) is the solvent (S), and
ammonia and water (NH₃—H₂O), in which the ammonia (NH₃) is the refrigerant fluid (R) and the water (H₂O) is the solvent (S).

15. The air conditioner according to claim 13, wherein said refrigeration circuit comprises a generation chamber in thermal communication with said burner and in fluid communication with a condenser, said condenser being in thermal communication with the outside environment and in fluid communication with said evaporator, said evaporator being in fluid communication with an absorption chamber, said absorption chamber being in turn in fluid communication with said generation chamber;
said refrigeration circuit being configurable at least in a cooling configuration for the cooling of the passenger compartment, wherein: the burner, by heating said binary compound in the generation chamber, causes the evaporation of at least part of the refrigerant fluid, separating it from the solvent and propelling it in the gaseous phase toward the condenser, in which said refrigerating fluid condenses, transferring heat to the outside environment, and then towards the vaporizer, in which it vaporizes, absorbing heat from the passenger compartment, and then toward the absorption chamber, in which it recombines with the solvent, reconstituting said binary compound; said absorption chamber being connected to the generation chamber by way of a delivery duct for the passage of the solvent from the generation chamber to the absorption chamber and a return duct for the passage of the binary compound from the absorption chamber to the generation chamber.

16. The air conditioner according to claim 15, wherein said evaporator and/or said condenser is arranged in thermal communication with a heat transfer liquid, which is arranged in thermal communication with the passenger compartment.

17. The air conditioner according to claim 15, wherein said refrigeration circuit can also be configured in a heating configuration for the heating of the passenger compartment, in which said condenser is arranged in thermal communication with the passenger compartment and said evaporator is arranged in thermal communication with the outside environment, so that heat is released by said refrigerant fluid to the passenger compartment and heat is absorbed from the outside environment.

18. The air conditioner according to claim 12, further comprising a thermoelectric generator arranged in thermal communication with said burner, so as to generate electric power from the heat generated by said burner, for powering elements that are complementary to the operation of said air conditioner.

19. The air conditioner according to claim 12, further comprising a hydraulic supply system for the transfer of the fuel from the tank of the vehicle to the burner; said hydraulic supply system comprising a drawing duct which has an end arranged inside said tank and/or a supplementary tank arranged in fluid communication with said burner and with said tank of the vehicle.

20. The air conditioner according to claim 19, wherein said hydraulic supply system also comprises a dosage pump for the creation of a flow of fuel from said tank of the vehicle to said burner; said dosage pump being configured to regulate said flow as a function of the thermal power required of the burner.

21. A method for the air conditioning of the passenger compartment of a vehicle of the type provided with an internal combustion engine and with a tank adapted to contain a fuel for supplying the engine,
the method including the following steps:
a) drawing fuel from the tank of the vehicle;
b) burning said fuel in a burner, generating heat;
c) using said heat generated by the burner to heat a binary compound which comprises a solvent and a refrigerant fluid, thus causing the evaporation of at least part of said refrigerant fluid;
d) passing said refrigerant fluid first into a condenser, making it liquefy, and then into an evaporator, in which it is made to evaporate at low pressure, cooling the surrounding air, and/or a heat transfer fluid which cools the air that surrounds it; and
e) conveying the air cooled in the preceding step inside the passenger compartment of the vehicle.

22. A motor vehicle comprising an air conditioner according to claim 12.
